(19) United States
(12) Patent Application Publication
(10) Pub. No.: US 2013/0332368 A1
(43) Pub. Date: Dec. 12, 2013

(54) PROJECT MANAGEMENT SYSTEMS AND METHODS

(71) Applicant: JUAN M. MANRIQUE, Surrey (GB)

(72) Inventor: JUAN M. MANRIQUE, Surrey (GB)

(73) Assignee: eTask Technologies, Ltd., Farnborough (GB)

(21) Appl. No.: 13/492,266

(22) Filed: Jun. 8, 2012

(51) Int. Cl. G06Q 10/00

(52) U.S. Cl. 705/301

(57) ABSTRACT

Project management systems and methods utilizing project components that are stored in a components library and which provide for the input of quality compliance parameters, the empirical analysis of real time project execution information, and the feedback of real-time project execution information to the components library.

### TECHNICAL FIELD

The present application relates to systems and methods for improved project management.

### BACKGROUND

Current project management tools and practices have shortcomings in efficiently achieving consistent delivery of projects and also in capturing information, knowledge and best practices during project execution and utilizing that information in the delivery of future projects. The present disclosure provides organizations with integrated systems and processes to, among other things, define, implement, control, improve, and share project-based best practices.

### SUMMARY

Project management systems and methods are disclosed. Some implementations may include the provision of an executive management interface for creating a project blueprint based on components stored in a components library, providing for the input of at least one quality compliance parameter for a project, providing a project management interface for executing a project based at least in part on the project blueprint, providing an empirical analysis module configured to collect real time project execution information, and providing for the feedback of real-time project execution information to the components library. The components may include historical execution information and the at least one quality compliance parameter may include an allowed deviation from historical execution information. The historical execution information may be expressed as an average, mean or standard deviation and the at least one quality compliance parameter may include an allowed deviation from historical execution information expressed in terms of a multiple of the standard deviation or a percent deviation from the average or mean. The at least one quality compliance parameter may include an allowed ad hoc task density, which may be determined from a process maturity metric.

An implementation may also include comparing real time project execution information to historical execution information and providing a notification to the executive management interface based on the comparison.

Ad hoc task density may also be determined during project execution, and a notification sent to the executive management interface based on the determination of the ad hoc task density. Stability metrics and asset utilization metrics may also be calculated based on the real time project execution information.

Feedback of real time project execution information to the components library may be done by the incorporation of real time project execution information into component historical execution information, where real time project execution information may include cost or effort information or textual information relating to best practices for implementing the component. The real time project execution information may first be sent to an executive management interface for approval prior to its incorporation into the component historical execution information.

Implementation may also enable sharing components in a collaborative library.

Some implementations may also include a components library, an executive management interface configured to allow creation of a project blueprint based on components stored in the components library and configured to allow the input of at least one quality compliance parameter for a project, a project management interface configured to allow execution of a project based at least in part on the project blueprint, and, an empirical analysis module configured to collect real time project execution information, wherein feedback of the real time project execution information is provided to the components library.

These and other features, aspects, and advantages of the present disclosure will become better understood with reference to the following description and claims.

### BRIEF DESCRIPTION OF THE DRAWINGS

Features, aspects, and embodiments of the disclosure are described in conjunction with the attached drawings, in which:

FIG. 1 shows a simplified system diagram for some aspects of the present disclosure.

FIG. 2 shows a simplified graphical representation of steps that may be used to implement an example of a method of the present disclosure.

### DETAILED DESCRIPTION

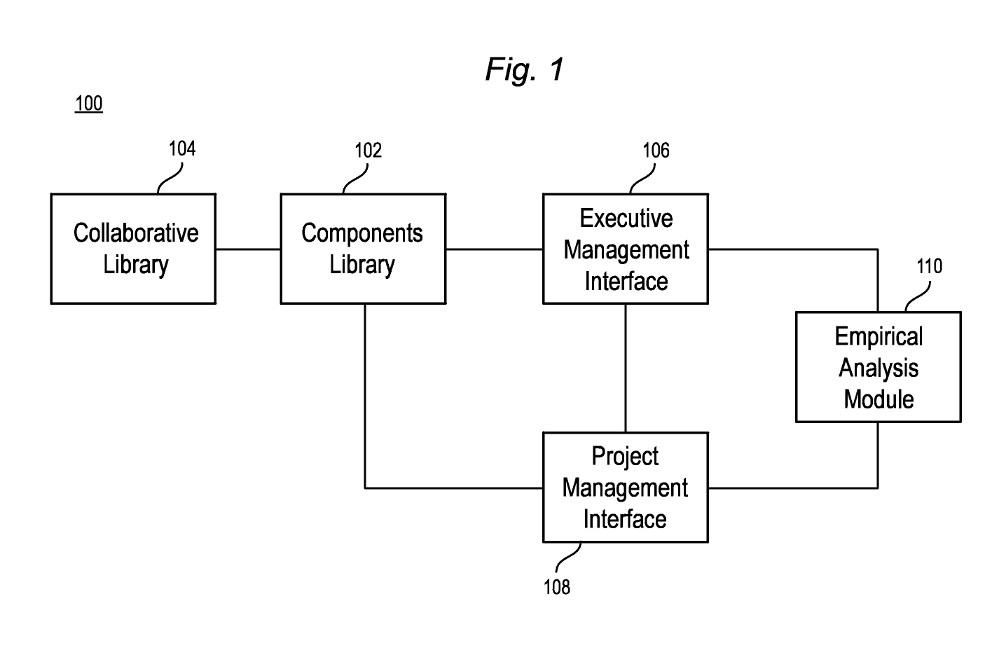

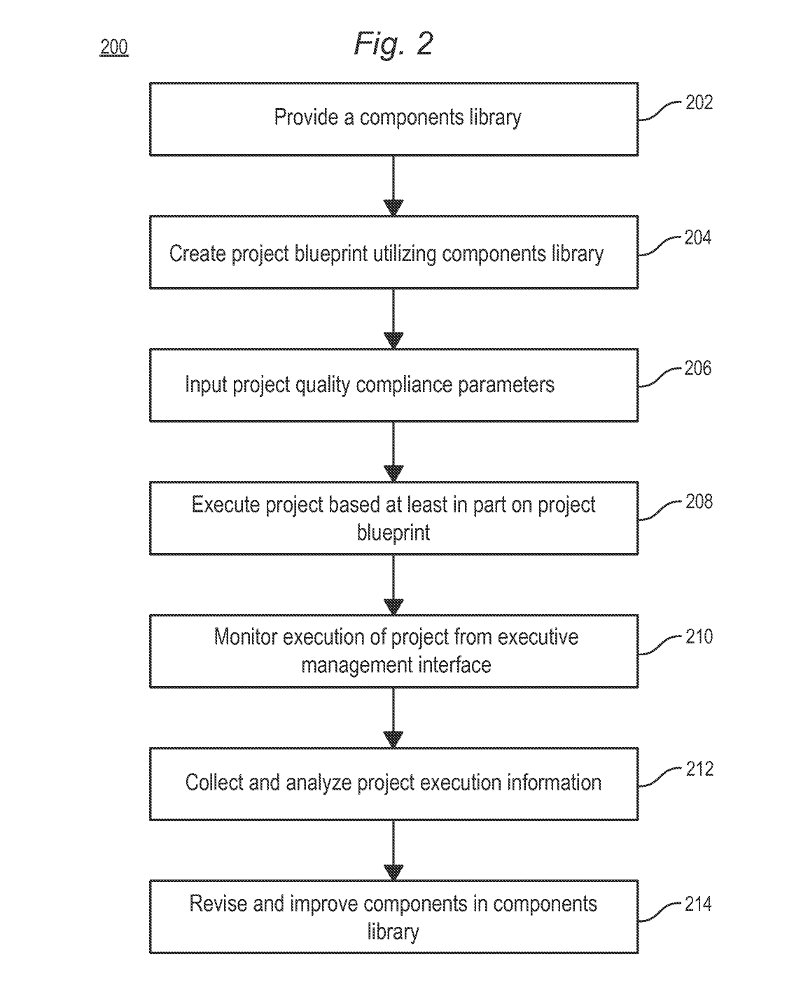

The disclosed systems and methods for project management improve efficiency and reduce costs through a convenient, integrated platform allowing for the definition of a project, quality compliance monitoring, and improvement of an organization's best practices, among other things. With the disclosed systems and methods, a project may be based on a “blueprint” that has been previously implemented or a new blueprint may be created for the project. Project blueprints may be created using components stored in a components library 102 as shown in FIG. 1, which depicts an exemplary system 100 of the present disclosure. When a components library 102 is provided, as in 202 in FIG. 2 (depicting an exemplary method 200 for utilizing the present disclosure), the stored components can be previously used tasks, work breakdown structures (e.g., coordinated groups of tasks that comprise portions of a complete blueprint), actual full blueprints, or other partial project building blocks. The components can be stored, for example, as data files or objects.

A task may be considered the fundamental building block of any project or blueprint. Tasks and their associated data structures enable the control of multiple aspects of project delivery and quality. Within a task, an organization is able to define numerous characteristics. For example, a task component may include a workflow or instructions on how certain aspects of a project should be carried out. A task may also include required inputs, for example, documents or supplies that are required in order to start the task. A task may also include required outputs, work-product, or deliverables that must be produced before the task is considered completed. A task may also include role requirements such as the level of skill or training required to properly carry out the task. A task may also include requirements for approvals before it can be considered completed or closed. A task may have helpful documentation within it or linked to it, such as, an organization's best practice policies, technical manuals or quality certification procedures. A task may also include notes from previous performers of the task, which could provide additional tips for efficiency or proper execution. A task may include data documenting historical execution information that may be obtained from implementations of the task in previous projects. This historical data may contain such parameters as personnel assigned, hours needed to complete the task, and cost data. Certain data contained within a task, such as, historical cost and effort, may be recorded using various statistical parameters such as average, mean and standard deviation. The task parameters disclosed herein are merely examples of information that can be included and are not intended to be an all inclusive list.

As noted, the component library 102 may include more than just tasks, it may also include tasks linked together into processes, phases or work breakdown structures that comprise a linked set of tasks commonly used in larger projects. Such structures may include defined relationships between tasks, commonly assigned roles across certain tasks, milestone requirements or other requirements. The component library may also include full project blueprints, including the tasks, phases and/or processes and the relationships between them for projects that may be run repeatedly.

In addition to the components library 102, a collaborative library 104 may be included with the disclosed system that can allow all, or portions of the components in components library 102, to be shared with other members of a sharing community. Members of the community may share with all or just selected members of the community, and permissions may be granted from read-only to full access and editing. With proper permissions, members may provide updates and additions to components, and their historical execution information may be added. Functionality may be included in the disclosed system to enable members to rate and make comments on different components in the library. Such collaboration and knowledge sharing can lead to more effective project management and execution.

The systems of the present disclosure may also include an executive management interface 106. This interface can be used to pull up an existing blueprint for a project or to create a new project blueprint utilizing components library 102 as in 204 in FIG. 2. When creating a new blueprint, components can be chosen that are necessary for implementation of the project and the relationships between the components may be entered. In addition, other requirements may be added to the blueprint, such as, required deliverables or compulsory outputs that must be provided before a task can be considered closed. Milestones, related requirements and other features may also be added to the blueprint.

Project quality compliance parameters may also be input, as at 206 in FIG. 2. These parameters may be integral portions of the blueprint that is created in 204, or may also be integrated into components stored in components library 102. Quality compliance parameters may allow users of the executive management interface 106 to monitor and enforce important aspects of a project's implementation and define the level of control they wish to have over the project. Example quality compliance parameters include cost limits or role rules that must be followed, or required approvals at certain stages of the project, which can be configured to allow the organization to handle parallel or sequential processes.

An additional quality compliance parameter that may be utilized is an allowed deviation from historical execution information. Components in the components library 102 may contain historical or expected execution information such as a cost or time to completion. This information may be stored as an average or mean and may include a standard deviation or other statistical parameters. When a blueprint is created, the system may use such historical information as the blueprint effort or planned/expected effort, or the user may change the planned effort. The systems and methods of the present disclosure will allow the user to define an acceptable deviation between the historical or planned effort and the real effort seen during project implementation. This acceptable deviation may be expressed in terms of a multiple of the component's stored standard deviation, a percent deviation from the average, mean, maximum or minimum, or any other desired manner.

Another quality compliance parameter that may be utilized is an allowed ad hoc task density. When project blueprints are executed, it is sometimes determined that extra tasks (“ad hoc” tasks) must be added to the project. A user of the executive management interface 106 may decide, however, that only a certain number of such tasks can be added to a blueprint. This ad hoc task density requirement may be expressed, for example, as a whole number or as a percentage of the number of components included in the blueprint. Historical ad hoc task information may also be saved in components library 102 and the allowed number of ad hoc tasks may be based on such saved information and could also be based on a process maturity metric. When projects or components are mature, and have been implemented numerous times, the number of ad hoc tasks required should be small (unless there is a significant problem with how the project is being implemented). The permitted ad hoc task density may thus be determined from historical average information and a simple maturity metric such as the number of times a process has been run. The permitted ad hoc task density may also be determined as a multiple of the standard deviation, as saved in the components library 102, or by any other maturity metric.

After a blueprint is created and quality compliance parameters have been determined, the project may be implemented via a project management interface 108, as shown at 208 in FIG. 2. The project is implemented at least in part using the blueprint, but, as mentioned above, ad hoc changes may need to be made during execution. The project management interface 108 may allow the user to assign resources, add, delete or modify tasks, update current status, costs, deliverables, etc., as the project progresses. Feedback may also be given as discussed further below. It is important to note that the project management interface 108 and the executive management interface 106 could be on separate machines, or they could be present and utilized on the same machine. The systems and methods of the present disclosure may be provided as traditional software programs or could also be delivered via software as a service over the internet. In addition, it is contemplated that the user of the executive management interface 106 and the user of the project management interface 108 may be different individuals or may be the same individual.

During implementation of a project, the executive management interface 106 can be configured to monitor the project as in 210 in FIG. 2. An empirical analysis module 110 in FIG. 1 may also be used to assist in the collection and analysis of real time project execution information as in 212 in FIG. 2. The empirical analysis module 110 can be configured to collect and analyze data during project implementation and also at the completion of a project. Information from the project management interface 108 is typically sent through the empirical analysis module 110 and then on to the executive management interface 106, although under certain contemplated configurations, project execution information may be sent directly from the project management interface 108 to the executive management interface 106 without passing through the empirical analysis module 110. It is important to note that the empirical analysis module 110, executive management interface 106 and project management interface 108 could be on separate machines, or they could be present and utilized on the same machine. The systems and methods of the present disclosure may be provided as traditional software programs or could also be delivered via software as a service over the internet.

During the monitoring of a project as in 210 in FIG. 2, reports and notifications can be provided. For example, information on the personnel assigned to complete various tasks can be reported and compared to the required role information in the project's components; notifications or warnings can be provided if the required skill level is not met. Ready for approval notifications can be provided and all of the required approvals can be tracked. Likewise, deliverables or compulsory outputs and milestone completion can be tracked. Deviations from any of the compliance parameters can be reported to either or both of the project management interface 108 and the executive management interface 106 so that the user(s) can take corrective action if necessary. As mentioned previously, it is contemplated that the executive and project management roles may be played by the same individual.

Monitoring of a project may include collecting real time project execution information and comparing it to project blueprint goals or historical execution information that may be saved in the components library 102 and in the blueprint. For example, if a task has not been completed 8 days after it had begun and the historical completion average for that task is 4 days, an alert or notification can be sent to the executive management interface 106 or the project management interface 108, which may detail the excessive time being spent on that particular task. This type of comparison to historical execution information can be performed for any of the metrics for which historical information is stored. Similarly, ad hoc task density may be recorded during project execution and a notification to the executive management interface 106 or the project management interface 108 can be provided based on a comparison of that density to project blueprint goals or historical execution information. Such monitoring results, comparisons and notifications can be displayed in tabular and graphical modes to assist the user(s) in understanding the data. When many projects are being executed simultaneously within an organization, information generated from all the projects may be displayed on one interface, enabling easy tracking of performance and notifications across various blueprints, project managers, divisions, customers, etc.

The systems and methods of the present disclosure also help organizations to learn from each project implementation through the acquisition and analysis of real time project execution information. Such feedback allows users to pinpoint areas of improvement and make informed decisions based on both qualitative and quantitative data. One type of feedback that may be provided is a blueprint adherence report. This report can calculate asset utilization metrics based on the real time project execution information and highlight the level of usage of all the different types of components and sub-components (e.g. deliverables, roles, documents, etc.) used in a blueprint. It may also show any new components or sub-components created during implementation of a project, as these are candidates to be included in components library 102 or in a revised blueprint.

The calculation of stability metrics based on real time project execution information may also be performed. The disclosed systems gather performance data every time a project is implemented and use the data to perform statistical analyses. Statistical analysis can indicate the stability of processes supporting a Blueprint, for example, a process is more stable when the standard deviation of project execution cost or time is small. Such analysis can be performed on any type of data included within a component or blueprint.

The data acquisition and analysis provided by the disclosed systems and methods can also help organizations improve upon their blueprints and components libraries, creating a constant feedback loop between blueprints and their implementation and moving away from re-inventing the wheel. In addition to the automatic data acquisition discussed above, any users of the systems may manually provide feedback on blueprints or components. For example, users can add notes, tips or suggestions for improvements to components. Such notes and information relating to best practices for implementing the component may be directly added to components in the components library 102 or they may first be approved at the executive management interface 106. Components in the components library 102 may thus be revised and improved as in 214 in FIG. 2.

The systems and methods disclosed herein may also include automatic or manual addition or feedback of real time project execution information into the components library 102. For example, real time cost or effort information for a component may be incorporated into the component's historical execution information saved in the components library 102, thereby updating and making the component's information more accurate. Such revision of component information stored in components library 102 may utilize the empirical analysis module 110 and/or may first pass through the executive management interface 106 for approval before being incorporated into components library 102.

While various embodiments in accordance with the disclosed principles have been described above, it should be understood that they have been presented by way of example only, and are not limiting. Thus, the breadth and scope of the invention(s) should not be limited by any of the above-described exemplary embodiments, but should be defined only in accordance with the claims and their equivalents issuing from this disclosure. The present disclosure contemplates that the calculations disclosed herein may be performed in a number of ways, applying the same concepts taught herein, and that such calculations are equivalent to the aspects disclosed. Furthermore, the advantages described above are not intended to limit the application of any issued claims to processes and structures accomplishing any or all of the advantages.

Additionally, section headings shall not limit or characterize the invention(s) set out in any claims that may issue from this disclosure. Specifically, and by way of example, although the headings refer to a “Technical Field,” such claims should not be limited by the language chosen under this heading to describe the so-called technical field. Further, the description of a technology in the “Background” is not to be construed as an admission that technology is prior art to any invention(s) in this disclosure. Neither is the “Summary” to be considered as a characterization of the invention(s) set forth in issued claims. Furthermore, any reference to this disclosure in general or use of the word “invention” in the singular is not intended to imply any limitation on the scope of the claims set forth below. Multiple inventions may be set forth according to the limitations of the multiple claims issuing from this disclosure, and such claims accordingly define the invention(s), and their equivalents, that are protected thereby.

1. A method comprising:
providing an executive management interface for creating a project blueprint based on components stored in a components library;
providing for the input of at least one quality compliance parameter for a project;
providing a project management interface for executing a project based at least in part on the project blueprint;
providing an empirical analysis module configured to collect real time project execution information;
comparing the real time project execution information to historical information stored in the components library or project blueprint;
providing for feedback of real-time project execution information to the components library.

2. The method of claim 1 wherein the components include historical execution information and wherein the at least one quality compliance parameter includes an allowed deviation from historical execution information.

3. The method of claim 1 wherein the components include historical execution information expressed as an average, mean or standard deviation and the at least one quality compliance parameter includes an allowed deviation from historical execution information expressed in terms of a multiple of the standard deviation or a percent deviation from the average or mean.

4. The method of claim 1 wherein the at least one quality compliance parameter includes an allowed ad hoc task density.

5. The method of claim 4 where the allowed ad hoc task density is determined from a process maturity metric.

6. The method of claim 1 further comprising providing a notification to the executive management interface based on the comparison of the real-time project execution information with the historical information stored in the components library or project blueprint.

7. The method of claim 1 wherein an ad hoc task density is determined during project execution and a notification to the executive management interface is provided based on the determination of the ad hoc task density.

8. The method of claim 1 further comprising calculation of stability metrics based on the real time project execution information.

9. The method of claim 1 further comprising calculation of asset utilization metrics based on the real time project execution information.

10. The method of claim 1 wherein the providing for feedback of real time project execution information to the components library includes an incorporation of real time project execution information into component historical execution information.

11. The method of claim 10 wherein the real time project execution information includes cost or effort information.

12. The method of claim 10 wherein the real time project execution information includes textual information relating to best practices for implementing the component.

13. The method of claim 10 wherein the real time project execution information is first sent to an executive management interface for approval prior to its incorporation into the component historical execution information.

14. The method of claim 1 further comprising sharing components in a collaborative library.

15. A system comprising:
a components library;
an executive management interface configured to allow creation of a project blueprint based on components stored in the components library and configured to allow the input of at least one quality compliance parameter for a project;
a project management interface configured to allow execution of a project based at least in part on the project blueprint; and,
an empirical analysis module configured to collect real time project execution information;
wherein the real time project execution information is compared to historical information stored in the components library or the project blueprint and feedback of the real time project execution information is provided to the components library.

16. The system of claim 15 wherein the components include historical execution information and wherein the at least one quality compliance parameter includes an allowed deviation from historical execution information.

17. The system of claim 15 wherein the components include historical execution information expressed as an average, mean or standard deviation and the at least one quality compliance parameter includes an allowed deviation from historical execution information expressed in terms of a multiple of the standard deviation or a percent deviation from the average or mean.

18. The system of claim 15 wherein the at least one quality compliance parameter includes an allowed ad hoc task density.

19. The system of claim 18 where the allowed ad hoc task density is determined from a process maturity metric.

20. The system of claim 15 wherein a notification is provided to the executive management interface based on the comparison of the real time project execution information with the historical information stored in the components library or project blueprint.

21. The system of claim 15 wherein ad hoc task density is determined during project execution and a notification to the executive management interface is provided based on the determination of the ad hoc task density.

22. The system of claim 15 further comprising calculation of stability metrics based on the real time project execution information.

23. The system of claim 15 further comprising calculation of asset utilization metrics based on the real time project execution information.

24. The system of claim 15 wherein the feedback of real time project execution information to the components library includes an incorporation of real time project execution information into component historical execution information.

25. The system of claim 24 wherein the real time project execution information includes cost or effort information.

26. The system of claim 24 wherein the real time project execution information includes textual information relating to best practices for implementing the component.

27. The system of claim 24 wherein the real time project execution information is first sent to the executive management interface for approval prior to its incorporation into the component historical execution information.

28. The system of claim 15 further comprising a collaborative library configured to share components.

29. The method of claim 1 wherein at least one component in the project blueprint includes a personnel requirement and the personnel requirement is compared to the real time project execution information including information about personnel actually assigned to a task.

30. The system of claim 15 wherein at least one component in the project blueprint includes a personnel requirement and the personnel requirement is compared to the real time project execution information including information about personnel actually assigned to a task.
